(19) United States
(12) Patent Application Publication
(10) Pub. No.: US 2015/0234212 A1
(43) Pub. Date: Aug. 20, 2015

(54) LIQUID CRYSTAL DISPLAY PANELS AND LIQUID CRYSTAL DISPLAY DEVICES INCLUDING LIQUID CRYSTAL DISPLAY PANELS

(71) Applicant: Samsung Display Co., Ltd., Yongin-City (KR)

(72) Inventors: Tae-Ho KIM, Asan-si (KR); Daisuke INOUE, Cheonan-si (KR); Mi-Suk KIM, Cheonan-si (KR); So-Youn PARK, Hwaseong-si (KR)

(21) Appl. No.: 14/546,017

(22) Filed: Nov. 18, 2014

(30) Foreign Application Priority Data
Feb. 17, 2014 (KR) 10-2014-0017591

(51) Int. Cl. G02F 1/137; G02F 1/1341; G02F 1/1335

(52) U.S. Cl. CPC G02F 1/137; G02F 1/133602; G02F 1/1341; G02F 2001/13712

(57) ABSTRACT

A liquid crystal display panel includes a first substrate, a second substrate opposed to the first substrate, and a liquid crystal layer which is disposed between the first substrate and the second substrate, and includes liquid crystal molecules having a uniform dielectric anisotropy (Δε) by a simultaneous reduction of a vertical permittivity (ε⊥) of the liquid crystal molecules and a horizontal permittivity (ε∥) of the liquid crystal molecules.

This application claims priority to Korean patent Application No. 10-2014-0017591, filed on Feb. 17, 2014, and all the benefits accruing therefrom under 35 U.S.C. §119, the disclosure of which is hereby incorporated by reference herein in its entirety.

### BACKGROUND

1. Field

Exemplary embodiments of the invention relate to liquid crystal display (“LCD”) panels and LCD devices including the LCD panels. More particularly, exemplary embodiments of the invention relate to LCD devices including liquid crystal layers in which vertical permittivities (ε⊥) of liquid crystal molecules and horizontal permittivities (ε∥) of the liquid crystal molecules are simultaneously reduced to substantially uniformly maintain dielectric anisotropies (Δε) of the liquid crystal molecules, and LCD devices including the LCD panels.

2. Description of the Related Art

A liquid crystal display (“LCD”) device may be employed in various electronic apparatuses such as a monitor, a laptop, a mobile phone, etc., as the LCD device has several advantageous such as relatively small thickness, light weight, low power consumption, etc. The LCD device may generally include an LCD panel displaying an image using an optical transmittance of liquid crystal molecules and a backlight assembly disposed under the LCD panel to provide the LCD panel with a light.

In order to improve a response time of the LCD device, the LCD device includes a liquid crystal layer including liquid crystal molecules with a low rotational viscosity coefficient or a high dielectric anisotropy. As the liquid crystal molecules have the low rotational viscosity coefficient, the response time of the LCD device having the liquid crystal molecules may be efficiently improved.

### SUMMARY

It may be difficult to improve both of an operating voltage and a response time of a liquid crystal display (“LCD”) device because liquid crystal molecules having low rotational viscosity coefficient may also have low dielectric anisotropy.

Exemplary embodiments provide an LCD panel including a liquid crystal layer including liquid crystal molecule that may have a dielectric anisotropy substantially uniformly maintained by simultaneously reducing a vertical permittivity of liquid crystal molecules and a horizontal permittivity of the liquid crystal molecules.

Exemplary embodiments provide an LCD device having the LCD panel.

According to one exemplary embodiment of the invention, there is provided an LCD panel including a first substrate, a second substrate, and a liquid crystal layer. The second substrate may be substantially opposed to the first substrate. The liquid crystal layer may be disposed between the first substrate and the second substrate. The liquid crystal layer may include liquid crystal molecules having a uniform dielectric anisotropy (Δε) by a simultaneous reduction of a vertical permittivity (ε⊥) of liquid crystal molecules and a horizontal permittivity (ε∥) of the liquid crystal molecules.

In exemplary embodiments, each of the vertical permittivity and the horizontal permittivity of the liquid crystal molecules may be reduced by a substantially constant ratio.

In exemplary embodiments, a ratio of reduction of the vertical permittivity may be substantially the same as a ratio of reduction of the horizontal permittivity.

In exemplary embodiments, the liquid crystal molecules may have a negative dielectric anisotropy.

In exemplary embodiments, an operating voltage of the LCD device may be decreased by the simultaneous reduction of the vertical permittivity of the liquid crystal molecules and the horizontal permittivity of the liquid crystal molecules.

In exemplary embodiments, a constant rotational viscosity (γ₁) of the liquid crystal molecules and an increased response speed of the LCD may be defined by the uniform dielectric anisotropy of the liquid crystal molecules.

In exemplary embodiments, a major axis of the liquid crystal molecules may be substantially perpendicularly aligned with respect to the first substrate and the second substrate when a voltage may not be applied to the liquid crystal layer.

In exemplary embodiments, a major axis of the liquid crystal molecules may be substantially perpendicularly aligned relative to an electric field, which may be generated between the first substrate and the second substrate, in a direction respectively from the first substrate and the second substrate toward a central portion of the liquid crystal layer when a voltage may be applied to the liquid crystal layer.

In exemplary embodiments, the applied voltage may be in a range of about 4.4 volts (V) to about 5.2 V.

In exemplary embodiments, a gap between the first substrate and the second substrate may be about 3.2 micrometers (μm).

According to another exemplary embodiment of the invention, there is provided an LCD device including an LCD panel and a back light assembly. The liquid crystal panel may include a first substrate, a second substrate substantially opposed to the first substrate, and a liquid crystal layer disposed between the first substrate and the second substrate. The liquid crystal layer may include liquid crystal molecules having a uniform dielectric anisotropy (Δε) by a simultaneous reduction of a vertical permittivity of the liquid crystal molecules and a horizontal permittivity of the liquid crystal molecules.

In exemplary embodiments, each of the vertical permittivity of the liquid crystal molecules and the horizontal permittivity of the liquid crystal molecules may be reduced by a substantially constant ratio.

In exemplary embodiments, a ratio of reduction of the vertical permittivity of the liquid crystal molecules may be substantially the same as a ratio of reduction of the horizontal permittivity of the liquid crystal molecules.

In exemplary embodiments, the liquid crystal molecules may have a negative dielectric anisotropy.

In exemplary embodiments, an operating voltage of the LCD device may be decreased by the simultaneous reduction of the vertical permittivity of the liquid crystal molecules and the horizontal permittivity of the liquid crystal molecules.

In exemplary embodiments, a constant rotational viscosity (γ₁) of the liquid crystal molecules and an increased response speed of the LCD may be defined by the uniform dielectric anisotropy of the liquid crystal molecules.

In exemplary embodiments, a major axis of the liquid crystal molecules may be substantially perpendicularly aligned relative to the first substrate and the second substrate when a voltage may not be applied to the liquid crystal layer, and a major axis of the liquid crystal molecules may be substantially perpendicularly aligned with respect to an electric field generated between the first and the second substrates, in a direction respectively from the first substrate and the second substrate toward a central portion of the liquid crystal layer when a voltage may be applied to the liquid crystal layer.

In exemplary embodiments, the applied voltage may be in a range of about 4.4 V to about 5.2 V.

In exemplary embodiments, a gap between the first substrate and the second substrate may be about 3.2 μm.

According to exemplary embodiments, the LCD panel may include the liquid crystal layer of which liquid crystal molecules may have the dielectric anisotropy substantially uniformly maintained by simultaneously reducing the vertical permittivity of the liquid crystal molecules and the horizontal permittivity of the liquid crystal molecules. The operating voltage of the LCD device may be reduced without substantial variation of the light transmittance of the liquid crystal layer. The dielectric anisotropy of the liquid crystal molecules may be constantly maintained, and thus the rotational viscosity of the liquid crystal molecules may be substantially uniformly maintained. Therefore, the operating voltage of the LCD device may be simultaneously reduced, so that the response speed of the LCD device may be efficiently improved. Further, the LCD device including the LCD panel may ensure enhanced quality of images.

### BRIEF DESCRIPTION OF THE DRAWINGS

Illustrative, non-limiting exemplary embodiments will be more clearly understood from the following detailed description taken in conjunction including the accompanying drawings.

FIG. 1 is a plan view illustrating exemplary embodiments of a liquid crystal display (“LCD”) device in accordance with the invention.

FIG. 2 is a cross-sectional view taken along line I-I′ in FIG. 1.

FIG. 3 is a cross-sectional view illustrating an LCD panel in a black mode taken along line II-II′ in FIG. 1.

FIG. 4 is a cross-sectional view illustrating an LCD panel in a white mode taken along line II-II′ in FIG. 1.

FIG. 5 is a graph illustrating variations of power consumptions relative to operating voltages when a vertical permittivity and a horizontal permittivity of liquid crystal molecules in a liquid crystal layer are simultaneously reduced in accordance with the invention.

FIG. 6 is a graph illustrating variations of power consumptions relative to white voltages when a vertical permittivity and a horizontal permittivity of liquid crystal molecules in a liquid crystal layer are simultaneously reduced in accordance with the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, LCD panels and LCD devices having the LCD panels in accordance with exemplary embodiments will be described detail with reference to the accompanying drawings.

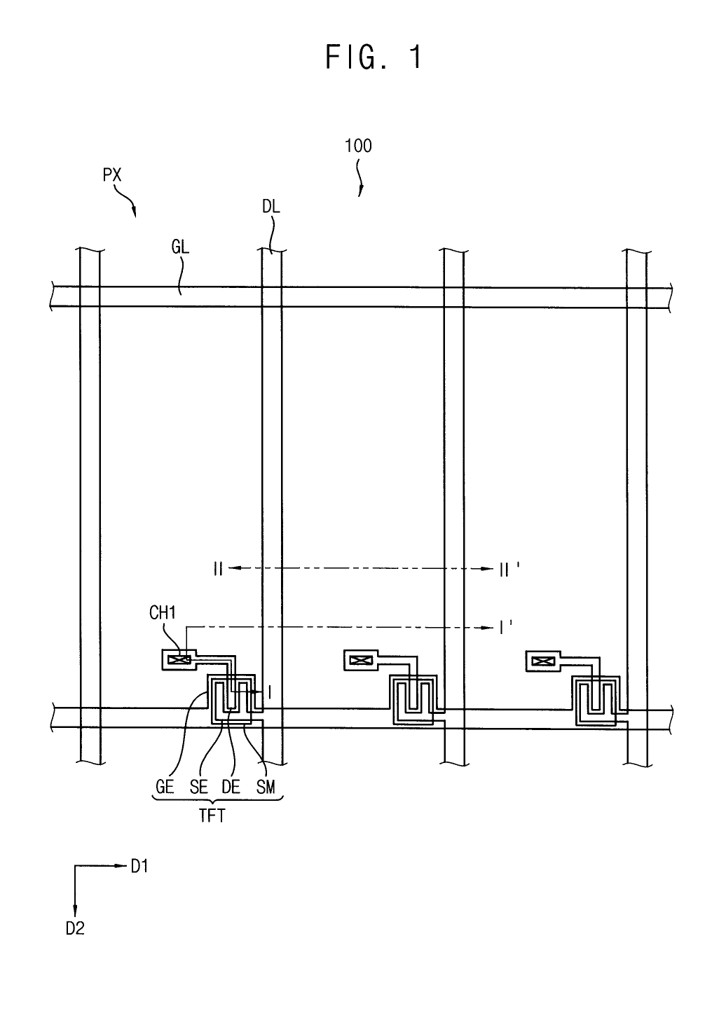

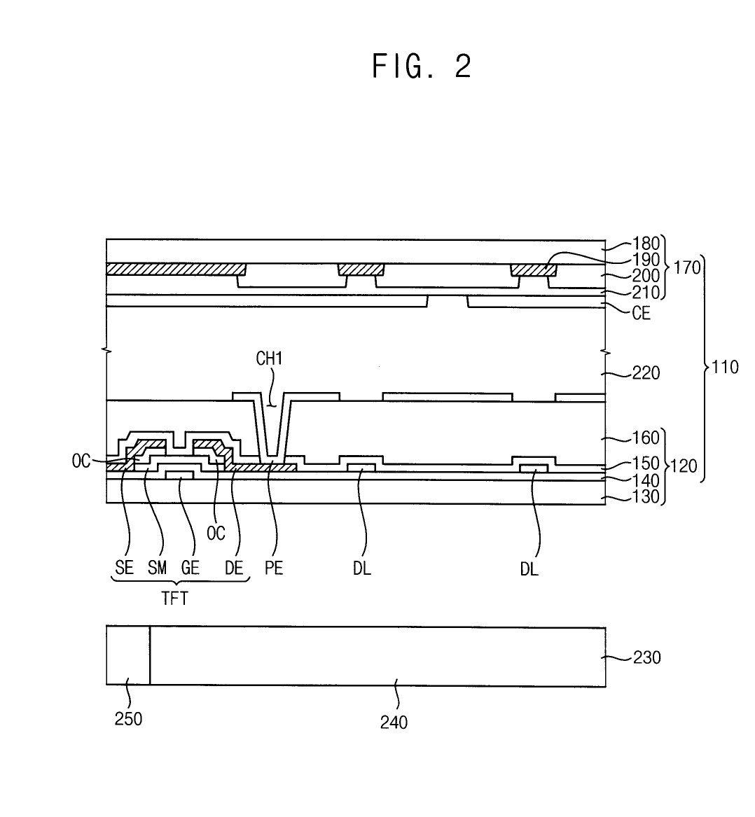

FIG. 1 is a plan view illustrating an LCD device in accordance with exemplary embodiments. FIG. 2 is a cross-sectional view taken along line I-I′ in FIG. 1.

Referring to FIGS. 1 and 2, an LCD device 100 may include an LCD panel 110 and a backlight assembly 230.

As illustrated in FIG. 2, the LCD panel 110 may include a first substrate 120, a second substrate 170 and a liquid crystal layer 220.

The first substrate 120 may include a first base substrate 130 on which a plurality of gate lines GL, a plurality of data lines DL, a plurality of switching elements TFT, a plurality of pixels PX, a gate insulation layer 140, a passivation layer 150, a first planarizing layer 160 and a pixel electrode PE are disposed.

In an exemplary embodiment, the first base substrate 130 may include a glass substrate, a quartz substrate and/or a resin substrate which may include polyethylene terephthalate resin, polyethylene resin, polycarbonate resin, etc.

The gate lines GL may be disposed on the first base substrate 130. In an exemplary embodiment, the gate lines GL may extend on the first base substrate 130 in a first direction D1. Adjacent gate lines GL may be spaced apart from each other along a second direction D2 substantially perpendicular to the first direction D1.

The data line DL may be located on the first base substrate 130. In an exemplary embodiment, the data lines DL may extend on the first base substrate 130 along the second direction D2. Adjacent data lines DL may be spaced apart from each other along the first direction D1.

Each of the switching devices TFT may be provided in a region where each of gate lines GL and each of the data lines DL are substantially overlapped. In this case, the regions defined by the gate lines GL and the data lines DL may be referred to as the pixels PX of the LCD device 100. However, the invention is not limited thereto, and the pixels PX of the LCD device 100 may not be defined by the gate lines GL and the data lines DL. In an exemplary embodiment, each thin film transistor for the switching device TFT may include a gate electrode GE, an active pattern SM, a source electrode SE, an ohmic contact OC and a drain electrode DE. Here, the drain electrode DE may make electrical contact with the pixel electrode PE.

The gate electrode GE may be electrically connected to the gate line GL. In an exemplary embodiment, each gate electrode GE may extend from each gate line GL along the second direction D2.

The gate insulation layer 140 may cover the gate line GL and the gate electrode GE on the first base substrate 130. In an exemplary embodiment, the gate insulation layer 140 may include silicon compound, metal oxide, etc. Here, the gate insulation layer 140 may include silicon oxide (SiOx), hafnium oxide (HfOx), aluminum oxide (AlOx), zirconium oxide (ZrOx), titanium oxide (TiOx), tantalum oxide (TaOx), etc. The above described elements may be used alone or in a combination thereof.

The active pattern SM may be substantially overlapped with the gate electrode GE on the gate insulation layer 140. In an exemplary embodiment, the active pattern SM may include polysilicon, partially crystallized silicon and/or micro crystalline silicon, which may be obtained by crystallizing amorphous silicon including impurities. In alternative exemplary embodiment, the active pattern SM may include an oxide semiconductor. That is, in an exemplary embodiment, the active pattern SM may include oxide of indium (In), zinc (Zn), gallium (Ga), tin (Sn), hafnium (Hf), etc. In an exemplary embodiment, the active pattern SM may include indium-zinc-tin oxide (“IZTO”), indium-gallium-zinc oxide (“IGZO”), hafnium-indium-zinc oxide (“HIZO”), etc.

The source electrode SE may be extend from the data line DL and may be substantially overlapped with a portion of the active pattern SM on the gate insulation layer 140. The drain electrode DE may be substantially overlapped with another portion of the active pattern SM. The drain electrode DE may be separated from the source electrode SE in the first direction D1. In an exemplary embodiment, the ohmic contact OC may be disposed between a portion of the active pattern SM and the drain electrode DE and between another portion of the active pattern SM and the source electrode SE. However, the invention is not limited thereto, and the ohmic contact OC may be omitted.

The passivation layer 150 may be disposed on the gate insulation layer 140 to cover the data line DL, the active pattern SM, the source electrode SE and the drain electrode DE. In exemplary embodiments, the passivation layer 150 may include an insulation material such as silicon oxide or silicon nitride.

The first planarizing layer 160 may be disposed on the passivation layer 150. In an exemplary embodiment, the first planarization layer 160 may include an organic insulation material or an inorganic insulation material. In an exemplary embodiment, the inorganic insulation material for the first planarization layer 160 may include benzocyclobutene-based resin, olefin-based resin, polyimide-based resin, acryl-based resin, polyvinyl-based resin, siloxane-based resin, silicon-based resin, etc.

The pixel electrode PE may be positioned on the first planarization layer 160. The pixel electrode PE may be electrically connected to the drain electrode DE through a contact hole CH1 defined through the passivation layer 150 and the first planarization layer 160. In an exemplary embodiment, the pixel electrode PE may include a transparent conductive material such as indium tin oxide (“ITO”) or indium zinc oxide (“IZO”).

The second substrate 170 may include a second base substrate 180 on which a light blocking pattern 190, a color filter pattern 200, a second planarization layer 210, and a common electrode CE are disposed.

The second substrate 170 may be substantially opposed to the first substrate 120. In an exemplary embodiment, the second base substrate 180 may include a material substantially the same as or substantially similar to a material in the first base substrate 130.

The light blocking pattern 190 may be disposed on the second base substrate 170. The light blocking pattern 190 may substantially correspond to a non-opened portion in which a light generated from the backlight assembly 230 may be blocked. The light blocking pattern 190 may block a light leaked at a boundary between the non-opened region and an opened region through which the light generated from the backlight assembly 230 may pass. In an exemplary embodiment, the light blocking pattern 190 may be substantially overlapped with the data line DL, the gate line GL and the thin film transistor TFT. That is, the light blocking pattern 190 may substantially correspond to a boundary between adjacent pixels PX. In an exemplary embodiment, the light blocking pattern 190 may include a photosensitive organic material including a pigment such as carbon black and the like.

The color filter pattern 200 may substantially correspond to the opened portion and may locate on the second base substrate 180 on which the light blocking pattern 190 is disposed. The color filter pattern 200 may be partially overlapped with the light blocking pattern 190. The color filter pattern 200 may be positioned between adjacent pixels PX. In this case, adjacent color filter patterns 200 may have different colors. In an exemplary embodiment, the color filter pattern 200 may include color filters such as a red filter, a green filter, and a blue filter.

The second planarizing layer 210 may substantially cover the light blocking pattern 190 and the color filter pattern 200. The second planarizing layer 210 may have a substantially flat upper face in accordance with the position of the second planarizing layer 210. The second planarizing layer 210 may include an organic insulation material or an inorganic material. In an exemplary embodiment, the second planarizing layer 210 may include benzocyclobutene-based resin, olefin-based resin, polyimide-based resin, acryl-based resin, polyvinyl-based resin, siloxane-based resin, silicon-based resin, etc.

The common electrode CE may be disposed on the second base substrate 170. In an exemplary embodiment, the common electrode CE may include a transparent conductive material. In an exemplary embodiment, the common electrode CE may include IZO, ITO, tin oxide, zinc oxide, etc.

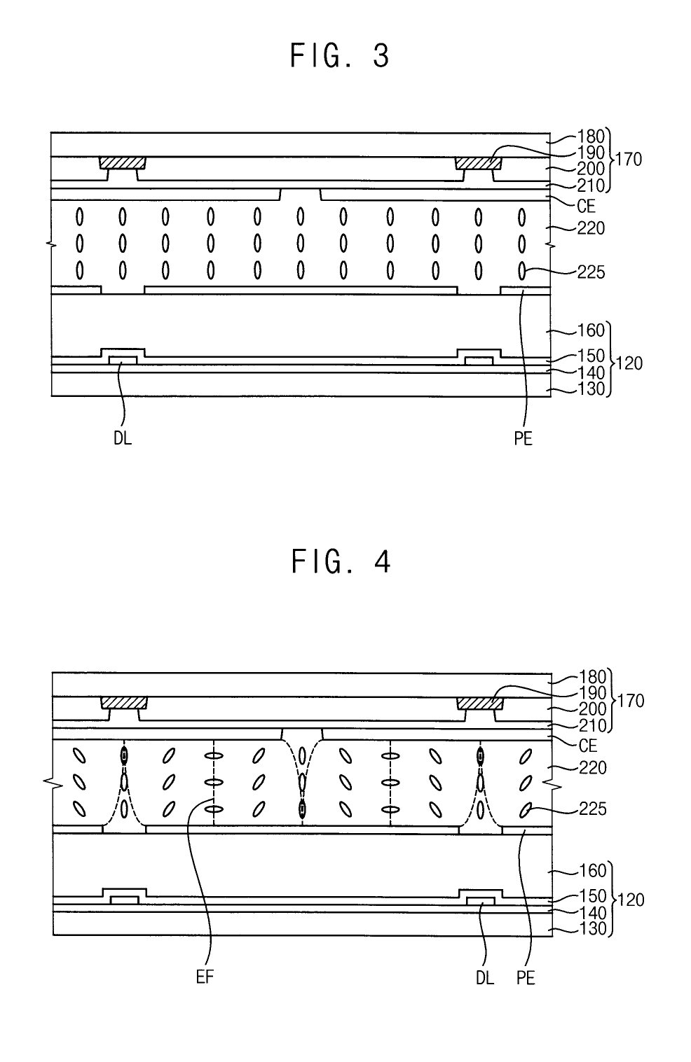

The liquid crystal layer 220 may be positioned between the first substrate 120 and the second substrate 170. The liquid crystal layer 220 may include liquid crystal molecules. The alignment of the liquid crystal molecules may be controlled by an electric field generated between the pixel electrode PE and the common electrode CE according to a voltage applied to the pixel electrode PE and/or the common electrode CE. Thus, the liquid crystal layer 220 may adjust the light transmittance of the pixels PX. The liquid crystal layer 220 in accordance with exemplary embodiments may include at least two kinds of liquid crystal molecules because a manufacturing of a liquid crystal having a desired characteristics using one kind of liquid crystal molecules may be substantially difficult. The liquid crystal molecules in the liquid crystal layer 220 and the alignment of the liquid crystal molecules will be described in detail with reference to FIGS. 3 and 4.

The backlight assembly 230 may be disposed under the LCD panel 110 to provide the LCD panel 110 with a light. The backlight assembly 230 may include a light guide plate 240 and a light source 250.

The light guide plate 240 may be disposed beneath the LCD panel 110. The light guide plate 240 may guide a light generated from the light source 250 toward the LCD panel 110.

The light source 250 may be disposed at a side of the light guide plate 240 to provide the light guide plate 240 with the light. In an exemplary embodiment, the light source 250 may include a light emitting diode (“LED”). In an exemplary embodiment, the LED may include a red luminous diode, a green luminous diode, and a blue luminous diode, for example. However, the invention is not limited thereto, and the LED may include other luminous diodes having various other colors. In an alternative exemplary embodiment, the LED may include a white luminous diode, for example.

Although the first substrate 120 locates beneath the liquid crystal layer 220 and the backlight assembly 230 emits the light toward the first substrate 120 in FIG. 2, this construction illustrates an exemplary embodiment and the configuration of the LCD panel 110 may not be limited thereto. In another exemplary embodiment, the first substrate 120 may be positioned on the liquid crystal layer, the second substrate may be disposed beneath the liquid crystal layer, and the backlight assembly may be located to emit the light toward the second substrate.

FIG. 3 is a cross-sectional view illustrating an LCD panel in a black mode taken along line II-II′ in FIG. 1. FIG. 4 is a cross-sectional view illustrating an LCD panel in a white mode taken along line II-II′ in FIG. 1.

Referring to FIGS. 3 and 4, the liquid crystal layer 220 disposed between the first substrate 120 and the second substrate 170 may include liquid crystal molecules 225. In exemplary embodiments, the liquid crystal layer 220 may have a negative dielectric anisotropy, so that the LCD device may operate in a mode where the liquid crystal molecules 225 are vertically aligned relative to the first substrate 120 and/or the second substrate 170. As illustrated in FIG. 3, when a voltage is not applied to the liquid crystal layer 220, the major axis of the liquid crystal molecules 225 may be perpendicularly aligned with respect to the first substrate 120 and/or the second substrate 170. Additionally, when a voltage is applied to the liquid crystal layer 220, the major axis of the liquid crystal molecules 225 may be perpendicularly aligned relative to an electric field EF from the first and the second substrates 120 and 170 toward a central portion of the liquid crystal layer 220. In this case, the voltage applied to the liquid crystal layer 220 may be in a range of about 4.4 volt (V) to about 5.2V, for example.

The response time Tᵣₑ of the LCD device may be defined by a sum of a rising time Tᵣ and a decay time T_{d}. The rising time Tᵣ means a time for aligning the liquid crystal molecules 225 perpendicularly to the electric field EF and maintaining such a stable state when the electric field EF is generated between the pixel electrode PE and the common electrode CE by an operating voltage. The decay time T_{d} denotes a time for returning the liquid crystal molecules 225 to an original alignment state when the electric field EF is removed. In an exemplary embodiment, the rising time Tᵣ may be a time when the liquid crystal molecules 225 may be substantially perpendicularly aligned relative to the electric field EF by the operating voltage, and the liquid crystal molecules 225 may be in a meta-stable state. Thus, the light transmittance of the liquid crystal layer 220 in a normally black vertically aligned liquid crystal mode may vary from about 10 percent (%) to about 90% during the rising time Tᵣ. The decay time T_{d} may be a time when the liquid crystal molecules 225 are returned to an original alignment state by the removal of the applied electric field EF. Hence, the light transmittance of the liquid crystal layer 220 may vary from about 90% to about 10% during the decay time T_{d}.

Generally, the rising time Tᵣ and the decay time T_{d} of the LCD device may be represented by the following Equation 1 and Equation 2.

$$\begin{matrix}{T}_{r} = \frac{{γ}_{1} {d}^{2} / {K}_{33} {π}^{2}}{{( V / {V}_{th} )}^{2} - 1} & Equation 1 \\ {T}_{d} = \frac{{γ}_{1} {d}^{2}}{{K}_{33} {π}^{2}} & Equation 2\end{matrix}$$

As for the above Equation 1 and Equation 2, γ₁ represents the rotational viscosity of the liquid crystal layer 220, and d indicates a cell gap between the first substrate 120 and the second substrate 170. In the Equation 1 and 2, K₃₃ denotes an elastic coefficient concerning an elastic restoring force in relation with the bend deformation of the liquid crystal layer 220. In the Equations 1 and 2, π² means the product of the permittivity of the liquid crystal molecules 225 in a vacuum state multiplied by the dielectric anisotropy of the liquid crystal molecules 225. In the Equation 1, V represents the operating voltage, and Vₜₕ means the threshold voltage of the liquid crystal layer 220. The threshold voltage Vₜₕ is referred to as a voltage when the variation of the light transmittance occurs in the liquid crystal layer 220.

As shown in the above Equation 1 and Equation 2, the rising time Tᵣ may be substantially proportional to the rotational viscosity γ₁ and the square of the cell gap d. The rising time Tᵣ may be inversely proportional to the square of the applied voltage divided by the threshold voltage, the permittivity of the liquid crystal molecules 225 and the dielectric anisotropy of the liquid crystal molecules 225. Further, the decay time Td may be proportional to the rotational viscosity γ₁ and the square of the cell gap d. The decay time Td may also be inversely proportional to K₃₃, the permittivity of the liquid crystal molecules 225 and the dielectric anisotropy of the liquid crystal molecules 225.

Considering the above Equations 1 and 2, the LCD device may have improved response speed as the rotational viscosity γ₁, the square of the cell gap d and the square of the applied voltage divided by the threshold voltage become smaller, or as K₃₃, the permittivity of the liquid crystal molecules 225 and the dielectric anisotropy of the liquid crystal molecules 225 becomes larger.

Hereinafter, examples according to the invention will be described, however, the invention may not be limited these examples.

### EXAMPLE 1

A cell gap between a first substrate and a second substrate was set to 3.2 micrometers (μm), a vertical permittivity of liquid crystal molecules was set to 4.8, and a horizontal permittivity of the liquid crystal molecules was set to 8.6, such that a dielectric anisotropy of the liquid crystal molecules was maintained by −3.8. Then, an operating voltage, a light transmittance, a white voltage and a power consumption of an LCD device were measured.

### EXAMPLE 2

A cell gap between a first substrate and a second substrate was set to 3.2 μm, a vertical permittivity of liquid crystal molecules was set to 3.8, and a horizontal permittivity of the liquid crystal molecules was set to 7.6 such that a dielectric anisotropy of the liquid crystal molecules was maintained by −3.8. Then, an operating voltage, a light transmittance, a white voltage and a power consumption of an LCD device were measured.

### EXAMPLE 3

A cell gap between a first substrate and a second substrate was set to 3.2 μm, a vertical permittivity of liquid crystal molecules was set to 2.8, and a horizontal permittivity of the liquid crystal molecules was set to 6.6, so that a dielectric anisotropy of the liquid crystal molecules was maintained by −3.8. Then, an operating voltage, a light transmittance, a white voltage and a power consumption of an LCD device were measured.

### EXAMPLE 4

A cell gap between a first substrate and a second substrate was set to 3.2 μm, a vertical permittivity of liquid crystal molecules was set to 1.8, and a horizontal permittivity of the liquid crystal molecules was set to 5.6, such that a dielectric anisotropy of the liquid crystal molecules was maintained by −3.8. Then, an operating voltage, a light transmittance, a white voltage and a power consumption of the LCD device were measured.

### EXAMPLE 5

A cell gap between a first substrate and a second substrate was set to 3.2 μm, a vertical permittivity of liquid crystal molecules was set to 0.8, and a horizontal permittivity of the liquid crystal molecules was set to 4.6, such that a dielectric anisotropy of the liquid crystal molecules was maintained by −3.8. Then, an operating voltage, a light transmittance, a white voltage and a power consumption of an LCD device were measured.

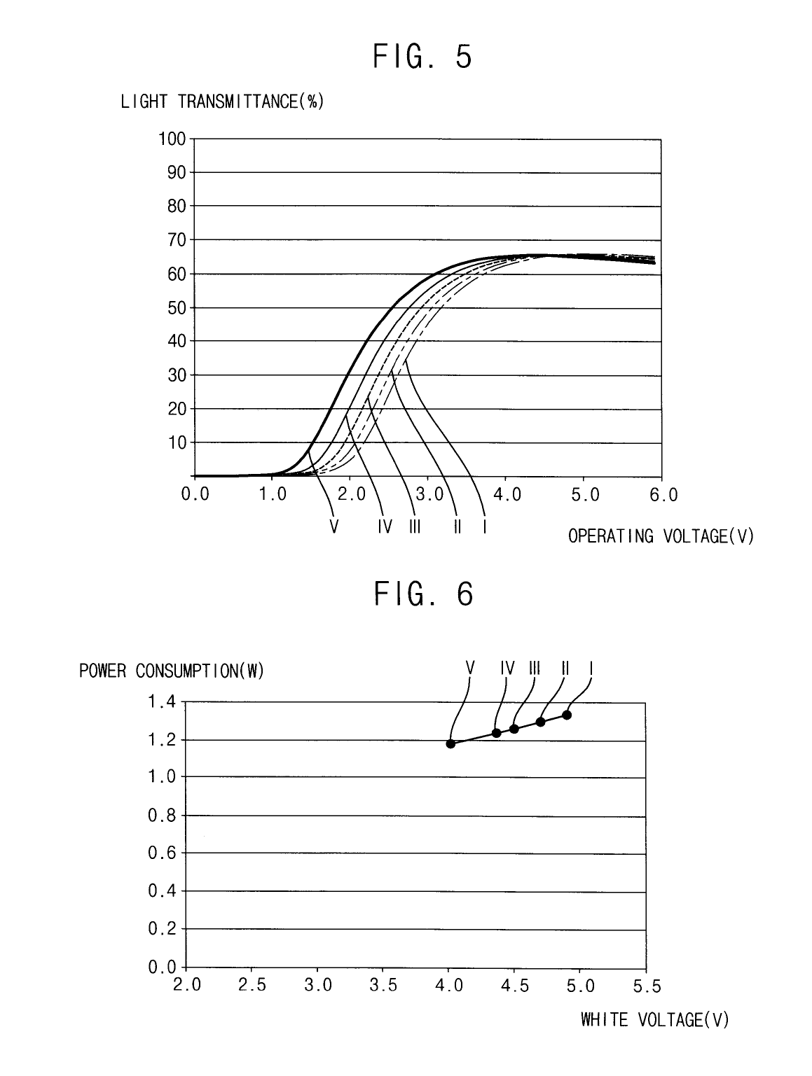

FIG. 5 is a graph illustrating the variations of the power consumptions relative to the operating voltages according to Examples of the invention when the vertical permittivity and the horizontal permittivity of the liquid crystal molecules in the LCD device are simultaneously reduced. FIG. 6 is a graph illustrating the variations of the power consumptions relative to the white voltages according to Examples of the invention when the vertical permittivity and the horizontal permittivity of the liquid crystal molecules are simultaneously reduced.

In FIGS. 5 and 6, the numerals I, II, III, IV and V denote Example 1, Example 2, Example 3, Example 4 and Example 5, respectively.

Referring to FIG. 5, the vertical permittivity of liquid crystal molecules and the horizontal permittivity of the liquid crystal molecules are simultaneously reduced to substantially maintain the dielectric anisotropy of the liquid crystal molecules. Then, the operating voltage and the rotational viscosity of the LCD device were measured.

Table 1 shows the operating voltages and the light transmittances of the LCD devices according to Example 1, Example 2, Example 3, Example 4 and Example 5. In Table 1, the rotational viscosity coefficient is measured in terms of millipascal seconds (mPa·s), and the power consumption is measured in terms of watts (W).

TABLE 1

| | Example 1 | Example 2 | Example 3 | Example 4 | Example 5 |
|---|---|---|---|---|---|
| Horizontal | 4.8 | 3.8 | 2.8 | 1.8 | 0.8 |
| permittivity | | | | | |
| (ε\|\|) | | | | | |
| Vertical | 8.6 | 7.6 | 6.6 | 5.6 | 4.6 |
| permittivity | | | | | |
| (ε⊥) | | | | | |
| Dielectric | −3.8 | −3.8 | −3.8 | −3.8 | −3.8 |
| anisotropy | | | | | |
| (Δε) | | | | | |
| Rotational | 112 | 112 | 112 | 112 | 112 |
| viscosity | | | | | |
| coefficient | | | | | |
| (mPa · s) | | | | | |
| Operating | 5.2 | 5.0 | 4.8 | 4.6 | 4.4 |
| voltage (V) | | | | | |
| Power | 100.2 | 100 | 99.8 | 99.6 | 100.2 |
| consumption | | | | | |
| (W) | | | | | |

Referring to Table 1 and FIG. 5, as the vertical permittivities of the liquid crystal molecules and the horizontal permittivities of the liquid crystal molecules according to Example 1 (I) to Example 5 (V) are decreased, the dielectric anisotropies, the rotational viscosities and the light transmittances of the liquid crystal molecules are substantially maintained. In this case, as the vertical permittivities and the horizontal permittivities of the liquid crystal molecules are reduced, the operating voltages of the LCD devices are gradually decreased. In an exemplary embodiment, in Example 5 (V), when the vertical permittivity of the liquid crystal molecules was set to 4.6, and the horizontal permittivity of the liquid crystal molecules was set to 0.8, the operating voltage of the LCD device is most efficiently decreased.

In Example 1 (I) through Example 5 (V), each of the vertical permittivity and the horizontal permittivity of the liquid crystal molecules was constantly reduced by a predetermined constant ratio, so the operating voltage of the LCD device was reduced without substantial variation of the light transmittance of the LCD device. Here, the dielectric anisotropy of the liquid crystal molecules may be constantly maintained and thus the rotational viscosity of the liquid crystal molecules may be constantly maintained. Therefore, the operating voltage of the LCD device may be decreased to thereby improve the response speed of the LCD device. Additionally, the LCD device including the LCD panel may ensure enhanced quality of images.

As for FIG. 6, the vertical permittivities of the liquid crystal molecules were reduced while the horizontal permittivities of the liquid crystal molecules were simultaneously decreased, so the dielectric anisotropies of the liquid crystal molecules were constantly maintained. Then, the white voltages and the power consumptions of the LCD devices were measured.

Table 2 shows the white voltages and the power consumption of the LCD devices according to Example 1 to Example 5.

TABLE 2

| | Example 1 | Example 2 | Example 3 | Example 4 | Example 5 |
|---|---|---|---|---|---|
| Horizontal | 4.8 | 3.8 | 2.8 | 1.8 | 0.8 |
| permittivity | | | | | |
| (ε\|\|) | | | | | |
| Vertical | 8.6 | 7.6 | 6.6 | 5.6 | 4.6 |
| permittivity | | | | | |
| (ε⊥) | | | | | |
| Dielectric | −3.8 | −3.8 | −3.8 | −3.8 | −3.8 |
| anisotropy | | | | | |
| (Δε) | | | | | |
| Rotational | 112 | 112 | 112 | 112 | 112 |
| viscosity | | | | | |
| coefficient | | | | | |
| (mPa · s) | | | | | |
| White | 4.6 | 4.5 | 4.4 | 4.5 | 4.1 |
| voltage (V) | | | | | |
| Power | 1.28 | 1.26 | 1.24 | 1.23 | 1.19 |
| consumption | | | | | |
| (W) | | | | | |

Referring to Table 2 and FIG. 6, as the vertical permittivities and the horizontal permittivities of the liquid crystal molecules according to Example 1 (I) to Example 5 (V) were decreased, the dielectric anisotropies and the rotational viscosities of the liquid crystal molecules were substantially maintained. In this case, as the vertical permittivities and the horizontal permittivities of the liquid crystal molecules were reduced, the power consumptions of the LCD devices were gradually decreased. In an exemplary embodiment, in Example 5 (V), when the vertical permittivity of the liquid crystal molecules was set to 4.6, and the horizontal permittivity of the liquid crystal molecules was set to 0.8, the power consumption of the LCD device was most efficiently reduced.

In Example 1 (I) through Example 5 (V), as each of the vertical permittivities and the horizontal permittivities of the liquid crystal molecules was reduced by a predetermined constant ratio, each of the dielectric anisotropies of the liquid crystal molecules was constantly maintained. Thus, the white voltage of the LCD device was decreased without substantial variation of the light transmittance of the LCD device. Further, the dielectric anisotropy of the liquid crystal molecules was constantly maintained, and thus the rotational viscosity of the liquid crystal molecules was substantially maintained. Therefore, the operating voltage of the LCD device may be reduced so that the LCD may ensure improve response speed. Further, the LCD device including the LCD panel may ensure enhanced quality of images.

Exemplary embodiments of the invention may be employed in any one of various electronic devices including display devices. In an exemplary embodiment, the LCD device according to exemplary embodiments may be employed in various electronic device such as a notebook computer, a laptop computer, a digital camera, a video camcorder, a cellular phone, a smart phone, a smart pad, a portable multimedia player (“PMP”), a personal digital assistant (“PDA”), a MP3 player, a navigation system, a television, a computer monitor, a game console, a video phone, etc.

The foregoing is illustrative of exemplary embodiments and is not to be construed as limiting thereof Although a few exemplary embodiments have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A liquid crystal display panel comprising:
a first substrate;
a second substrate opposed to the first substrate; and
a liquid crystal layer which is disposed between the first substrate and the second substrate, and includes:
liquid crystal molecules having a uniform dielectric anisotropy (Δε) by a simultaneous reduction of a vertical permittivity (ε⊥) of the liquid crystal molecules and a horizontal permittivity (ε∥) of the liquid crystal molecules.

2. The liquid crystal display panel of claim 1, wherein each of the vertical permittivity and the horizontal permittivity of the liquid crystal molecules is reduced by a constant ratio.

3. The liquid crystal display panel of claim 2, wherein a ratio of reduction of the vertical permittivity is the same as a ratio of reduction of the horizontal permittivity.

4. The liquid crystal display panel of claim 1, wherein the liquid crystal molecules have a negative dielectric anisotropy.

5. The liquid crystal display panel of claim 4, wherein an operating voltage of the liquid crystal display device is decreased by the simultaneous reduction of the vertical permittivity and the horizontal permittivity of the liquid crystal molecules.

6. The liquid crystal display panel of claim 5, wherein a constant rotational viscosity (γ₁) of the liquid crystal molecules and an increased response speed of the liquid crystal display are defined by the uniform dielectric anisotropy of the liquid crystal molecules.

7. The liquid crystal display panel of claim 4, wherein a major axis of the liquid crystal molecules is perpendicularly aligned relative to the first substrate and the second substrate, when a voltage is not applied to the liquid crystal layer.

8. The liquid crystal display panel of claim 4, wherein a major axis of the liquid crystal molecules is perpendicularly aligned relative to an electric field generated between the first and the second substrates, in a direction respectively from the first and the second substrates, toward a central portion of the liquid crystal layer, when a voltage is applied to the liquid crystal layer.

9. The liquid crystal display panel of claim 7, wherein the voltage is in a range of about 4.4 volts to about 5.2 volts.

10. The liquid crystal display panel of claim 1, wherein a gap between the first substrate and the second substrate is about 3.2 micrometers.

11. A liquid crystal display device comprising:
a liquid crystal display panel comprising:
a first substrate;
a second substrate opposed to the first substrate; and
a liquid crystal layer disposed between the first substrate and the second substrate, the liquid crystal layer including liquid crystal molecules having a uniform dielectric anisotropy by a simultaneous reduction of a vertical permittivity of the liquid crystal molecules and a horizontal permittivity of the liquid crystal molecules; and
a backlight assembly disposed beneath the liquid crystal display panel and configured to provide light toward the liquid crystal display panel.

12. The liquid crystal display device of claim 11, wherein each of the vertical permittivity and the horizontal permittivity of the liquid crystal molecules is reduced by a constant ratio.

13. The liquid crystal display device of claim 12, wherein a ratio of reduction of the vertical permittivity is the same as a ratio of reduction of the horizontal permittivity.

14. The liquid crystal display device of claim 11, wherein the liquid crystal molecules have a negative dielectric anisotropy.

15. The liquid crystal display device of claim 14, wherein an operating voltage of the liquid crystal display device is decreased by the simultaneous reduction of the vertical permittivity and the horizontal permittivity of the liquid crystal molecules.

16. The liquid crystal display device of claim 15, wherein a constant rotational viscosity (γ₁) of the liquid crystal molecules and an increased response speed of the liquid crystal display are defined by the uniform dielectric anisotropy of the liquid crystal molecules.

17. The liquid crystal display device of claim 14, wherein a major axis of the liquid crystal molecules is perpendicularly aligned relative to the first substrate and the second substrate, when a voltage is not applied to the liquid crystal layer, and
wherein a major axis of the liquid crystal molecules is perpendicularly aligned relative to an electric field generated between the first and the second substrates, in a direction respectively from the first and the second substrates, toward a central portion of the liquid crystal layer, when a voltage is applied to the liquid crystal layer.

18. The liquid crystal display device of claim 17, wherein the voltage is in a range of about 4.4 volts to about 5.2 volts.

19. The liquid crystal display device of claim 11, wherein a gap between the first substrate and the second substrate is about 3.2 micrometers.

20. A method for manufacturing a liquid crystal display device, the method comprising:
providing a liquid crystal display panel comprising a first substrate, and a second substrate opposed to the first substrate;
disposing a liquid crystal layer including liquid crystal molecules between the first substrate and the second substrate; and
providing the liquid crystal molecules having a uniform dielectric anisotropy (Δε) by simultaneously reducing a vertical permittivity (ε⊥) of the liquid crystal molecules and a horizontal permittivity (ε∥) of the liquid crystal molecules.
